(19) United States
(12) Patent Application Publication
(10) Pub. No.: US 2012/0091736 A1
(43) Pub. Date: Apr. 19, 2012

(54) Housing element and closing element provided with rollover resistance

(76) Inventors: Sebastian Dammers, Gerolsbach (DE); Eric Acker, Haguenau (FR); Erwin Kaspar, Magstadt (DE)

(21) Appl. No.: 10/572,166

(22) PCT Filed: Sep. 13, 2004
(86) PCT No.: PCT/EP04/10454

§ 371 Date: Nov. 6, 2006

(51) Int. Cl. E05B 65/12; E05C 1/16; E05C 19/00

(52) U.S. Cl. 292/164; 292/2; 292/144

(57) ABSTRACT

The invention relates to a closing element for a housing which can be closed, said housing comprising a covering frame which covers the opening of the housing at least in certain areas, at least one closing catch which is arranged in a displaceable manner in the frame, a locking element which is used to lock the at least one closing catch, a manual or motor drive which is used to displace the locking element between a first position, wherein the at least one closing catch, a manual be displaces and is not locked, and a second position, wherein the closing catch is locked by the locking element, also comprising a safety device which is used to lock at least one of the closing catches in the case of fast acceleration and/or a large amount of force being exerted onto the locking element.

### FIELD OF INVENTION

The present invention relates to a housing and to a closing element for such housings which has a rollover safety device. Such housings are used for example as storage compartments in motor vehicles. If corresponding cavities have to be closed, they are closed with covers which are held in the closed state by means of closing elements. However the present invention may be used also in all other areas in which spaces are closed by covers.

### SUMMARY OF INVENTION

The present invention describes a housing and a closing element for same, by means of which a housing cover can be securely closed. In particular, the locking of the housing cover in the locked state should be guaranteed.

According to the invention, the closing element has a covering frame which bears the individual parts of the closing element. This covering frame surrounds at least partially the opening of the housing to be closed. The covering frame can here be a separate element which is inserted into or attached to the housing; however it can also be embodied as one piece with the housing itself.

Arranged on this covering frame is at least one closing catch which is mounted so as to be displaceable. As the cover is closed, this closing catch is pressed to the side by the cover and then snaps into corresponding grooves in the cover in order to hold the cover in its closed position.

If the closing catch is resiliently mounted, such that it can be pressed in and moves itself back into its original position, a closure can be produced which can be closed and opened without active actuation, i.e. in which it is not necessary to open a lock in order to open the cover. This is achieved advantageously in that the closing catch has in its engagement area in each case lead-in slopes such that the closing cover presses onto the one lead-in slope and thus pushes the closing catch to the side when the lid is being closed. If the cover is being opened, it is sufficient to pull on it and the cover slides along the second lead-in slope on the other side of the closing catch and presses the closing catch back into its housing again such that the cover can be opened.

What is essential now is that in the closing element according to the invention a locking element is provided which locks at least one of the closing catches when the closing element is to be locked. The locking takes place here by means of a manual or motor drive, e.g. in connection with a vehicle's central locking system which actuates the locking element. In a first position, the locking element permits any otherwise possible movement of the closing catch such that the closing element is not locked. In a second position, the closing catch is locked such that it cannot be pushed back any more. In this case, therefore, it is no longer possible to pull open easily an already closed cover.

Advantageously, an unlocking element is furthermore provided, for example a release pin, which only allows the locking element to assume the second position when the cover is also actually closed. Such an unlocking element represents an independent aspect of the present invention. When the cover is open, this prevents the closing catches from being able to be pressed in any more by faulty actuation and thus the cover can also no longer be closed. The unlocking device is only triggered by closing the lid, and it then releases the locking element which for its part then assumes the second position and thus can lock the closing catches. The automatic consequence of this is that, in the case of a previously locked closing element, closing the cover is still easily possible, but then the cover also actually remains locked.

This device makes possible secure closing of the housing cover. When the vehicle is locked, this closing element guarantees the locking of the housing cover.

Advantageously two closing catches are fitted the one beside the other, thus the closing element is also suitable for flip-flap covers, i.e. covers which can be opened about three axes. In each case the two closing catches already secure the cover at two points whilst the cover itself only has to be rotatably attached at one point.

Crucial about the present invention is furthermore the fact that a safety device is provided which, in the event of the action of high forces or great acceleration, locks the closing catch or the plurality of closing catches and thus, e.g. in the case of a vehicle overturning or having an accident, locks the closing catch, independently of whether the locking element has already locked one of the closing catches or not, i.e. for example independently of the state of the vehicle's central locking system. This is particularly necessary if the cover can, as provided here, be opened without active actuation.

This rollover or crash safety device can be designed in such a way that a ball is mounted in a socket. Opposite the bearing is arranged a lever which can be moved by the ball. The lever has at one of its ends an element for engaging in a groove in the associated closing catch. For this purpose, the lever can be advantageously rotatably attached at a first end and have at its second end a pin which has teeth. If the closing catch also has teeth at the corresponding point, e.g. a toothed rod, the teeth of the lever can engage in the teeth of the closing catch and thus fix the closing catch when the lever is actuated by the ball.

In normal use of the vehicle, the ball remains lying in its socket and does not actuate the lever. In this manner, the closing catch is not fixed and can therefore be moved. Normal use of the cover is possible.

If the vehicle over turns or crashes, the ball is hurled out of the socket and presses on the opposite lever, such that one end of this lever engages in the corresponding teeth in the closing catch and locks said catch. Thus in the event of an accident, for example, this causes the cover not to be able to open.

What is advantageous about the present invention, therefore, is that opening of the cover is prevented in the event of the vehicle overturning or having an accident.

Furthermore, simple mounting of the individual closing parts or of the closing element is made possible. The covering frame, on which the additional elements of the closing element are arranged, makes possible tolerance compensation between the housing and the cover during assembly.

Finally, any faulty actuation of the closing element is provided by the closing mechanism described here.

### BRIEF DESCRIPTION OF DRAWINGS

In what follows, an example of a closing element according to the invention will be described, the figures showing:

FIG. 1 shows a closing element in the open state, viewed from obliquely above according to an exemplary embodiment of the present invention;

FIG. 2 shows the closing element viewed from below and behind (here always in relation to FIG. 1), in the open state;

FIG. 3 shows parts of the closing element viewed from above, in an intermediate position;

FIG. 4 shows the closing element viewed from below, in the intermediate position;

FIG. 5 shows the closing element in a sectional view from above, in the intermediate position;

FIG. 6 shows a detail of an area of the closing element, in the intermediate position;

FIG. 7 shows a view of a detail of the closing element from obliquely below, in the intermediate position; and

FIG. 8 shows the rollover locking device of the closing element in a detailed view, seen from the side.

Here and in what follows, identical and similar reference numerals are used for identical and similar elements, such that in some cases their description is not repeated in connection with the subsequent figures.

### DETAILED DESCRIPTION

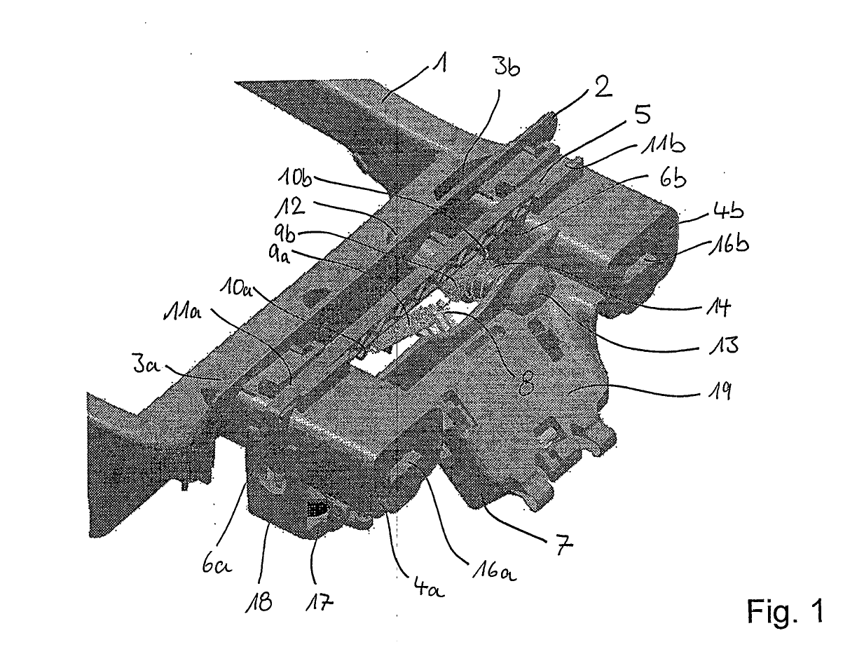

FIG. 1 shows a closing element according to an exemplary embodiment of the present invention for a vehicle glove compartment, viewed from obliquely above. Reference numeral 1 here designates a covering frame which covers the opening of a housing at least partially. A fixing rail 2 is arranged on this covering frame at right angles to same. This fixing rail 2 is interrupted by closing catches 3a and 3b as well as by a release pin 12. These three elements are all resiliently mounted, and protrude into the area which is closed by a cover, such that as the cover is closed, the closing catches 3a and 3b and the release pin 12 are pressed back.

On the other side of the fixing rail 2 are arranged housings 4a and 4b for the closing catches 3a,3b. Above the closing catches 3a and 3b extends from one of the closing catches to the other a stay bar 5 which runs in grooves 11a, 11b arranged in the housings 4a, 4b. This stay bar 5 has two downwardly protruding engagement elements 6a, 6b which are arranged adjacent to the closing catches 3a and 3b.

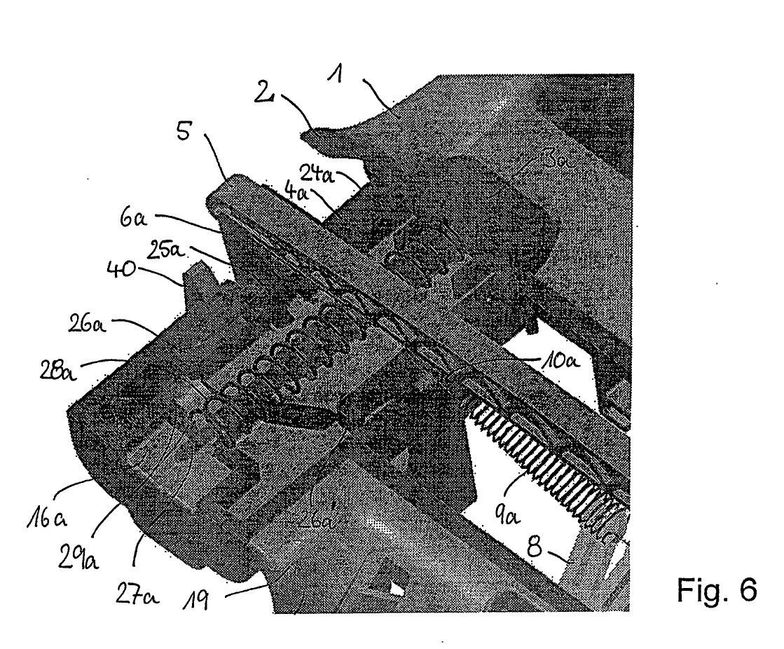

The stay bar is moved to and fro between two positions by an electric drive 7 which is controlled by the vehicle's central locking system, via drivers 8 moved by said system. The drive 7 is here arranged in a housing 19 which forms part of the closing element. Two springs 9a and 9b are suspended in the drivers 8 and extend in each case to the side of the drivers in the direction of movement of the stay bar 5 and are suspended in two receivers 10a and 10b for the springs, which are embodied as one piece with the stay bar. If the driver 8 is now moved to the left by the motor 7, the stay bar also moves towards the left into a first position. In this position, the engagement elements 6a and 6b are disengaged to the maximum extent, such that they do not come into engagement with grooves 25a, 25b (see FIG. 6) in the closing catches 3a and 3b which are guided in the housings 6a and 6b. The closing catches 3a and 3b are thus completely displaceable in their housings 4a, 4b. If the driver 8 is moved towards the right, the stay bar 5 also moves in the direction of the closing catch 3b. This causes the engagement elements 6a and 6b to be led through openings into the housings 4a, 4b and engage there in grooves 25a, 25b which are arranged in the closing catches 3a, 3b. The closing catches 3a and 3b are therefore fixed in the thus-defined second position of the stay bar 5.

The function of the release pin 12, which plays a role here, is described in more detail further on.

Furthermore in the region of the closing catch 3 a rollover and crash locking device 17 is arranged on the closing element by means of a mounting element 18. This rollover safety device 17 is also described in detail further on.

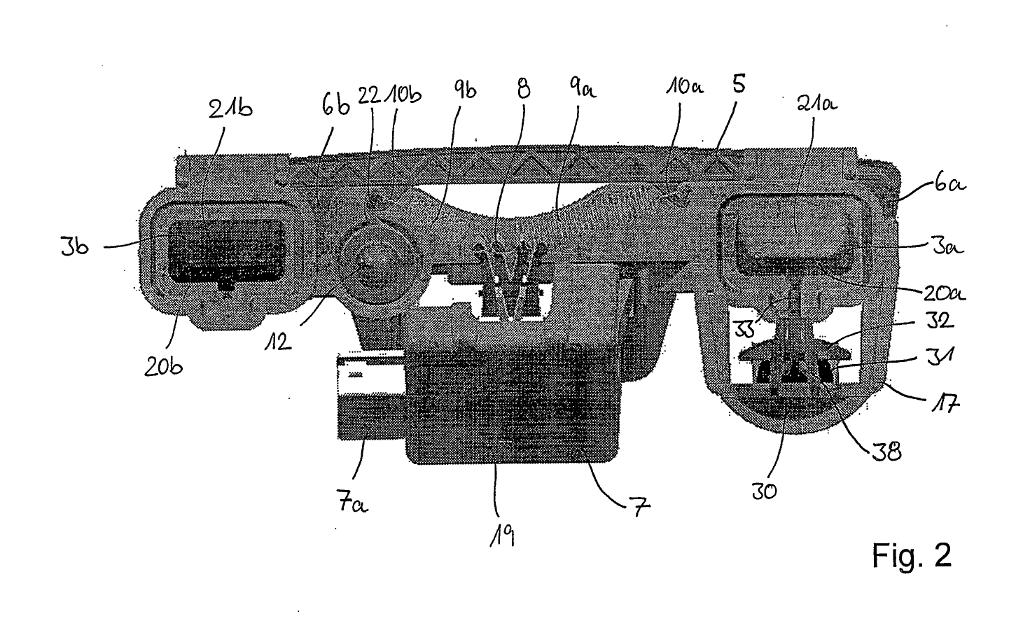

FIG. 2 shows a view of the closing element from the left and above (in relation to FIG. 1).

As can be clearly recognised, the closing catches 3a and 3b have two slopes 20a, 20b or 21a, 21b respectively. These lead-in slopes extend at various angles. A cover which is to be closed, moves down from above towards the closing catches 3a and 3b and presses on the flatter lead-in slopes 21a, 21b. This causes the closing catches 3a, 3b to be pressed, perpendicularly with respect to the plane of the drawing, backwards into their housing 4a, 4b, such that the cover can be closed. For opening the cover, it is merely necessary to pull on it since it then presses on the lower, steeper slopes 20a, 20b and also presses the closing catches 3a and 3b backwards, perpendicularly with respect to the plane of the drawing. In each case, there are to be provided in the cover two depressions or grooves corresponding to the closing catches 3a and 3b, into which grooves or depressions the closing catches 3a and 3b enter in the closed state, and thus can securely lock the cover.

As can be recognised in FIG. 2, the release pin 12 has a driver 22, which engages in the spring receiver 10b. The spring receiver 10b here represents a stop which can be actuated by the driver 22.

Also shown in FIG. 2 is the housing cover 19 for the electric motor 7 enclosed therein. The bushing 7a of the electrical contact for the electric motor 7 protrudes laterally from the housing cover.

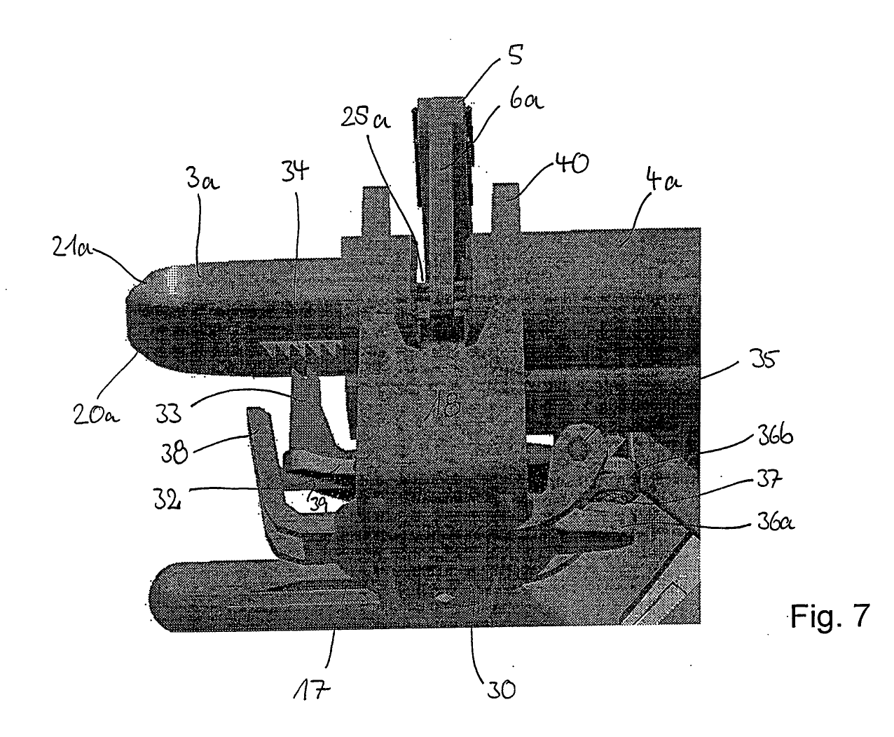

Shown also in FIG. 2 is the rollover safety device 17. This has a socket 30 in which a ball 31 is mounted. The ball 31 is covered by a lever 32, to one end of which a pin 33 is secured. This pin has teeth at its upper point which can be brought into engagement with a corresponding set of teeth 34 (see FIG. 7) on the closing catch 3a. In the event of a crash, the ball is pressed upwards, and this also causes the lever 32 and the pin 33 to move upwards and the closing catch 3a then to lock. The lever 32 and the pin 33 are supported in a guide 38, such that the engagement of the two sets of teeth at the end of the pin 33 is ensured.

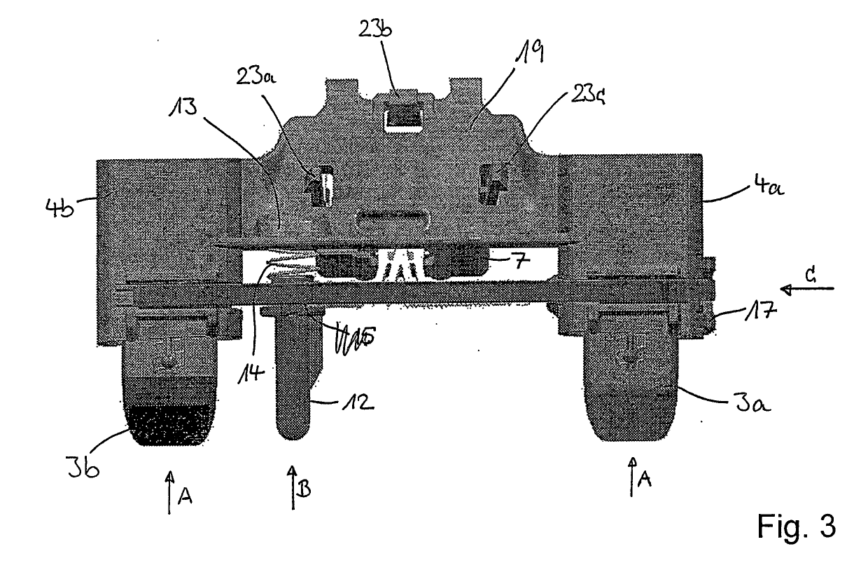

FIG. 3 shows a view from above of parts of the closing element according to the invention in an intermediate position. As in FIG. 1, the closing catches 3a and 3b are again shown in a completely disengaged state in FIG. 3. The security pin 12 is also not pressed in, i.e. the system is shown with the cover open. The reference numerals 23a, 23b and 23c designate catches by means of which the housing which surrounds the electric drive 7 can be securely locked. This provides the possibility of opening the housing such that for example faulty electric drives 7 can be easily replaced.

In FIG. 3 it is now shown that the release pin 12 is mounted in a bearing 13 by means of a spring 14. The spring 14 ensures that the release pin is always disengaged to the maximum extent unless it is actively pressed in. In this state, the driver 22 (see FIG. 2) blocks the stay bar 5 in such a way that it cannot completely reach the second position in which its engagement elements 6a or 6b could engage in the corresponding grooves 25a, 25b in the closing catches 3a, 3b. This means that, when the cover is open, faulty locking of the closing catches 3a or 3b due to actuation of the central locking system is prevented. Faulty actuation and thus blocking of the open cover in an attempt to close it is prevented in this way.

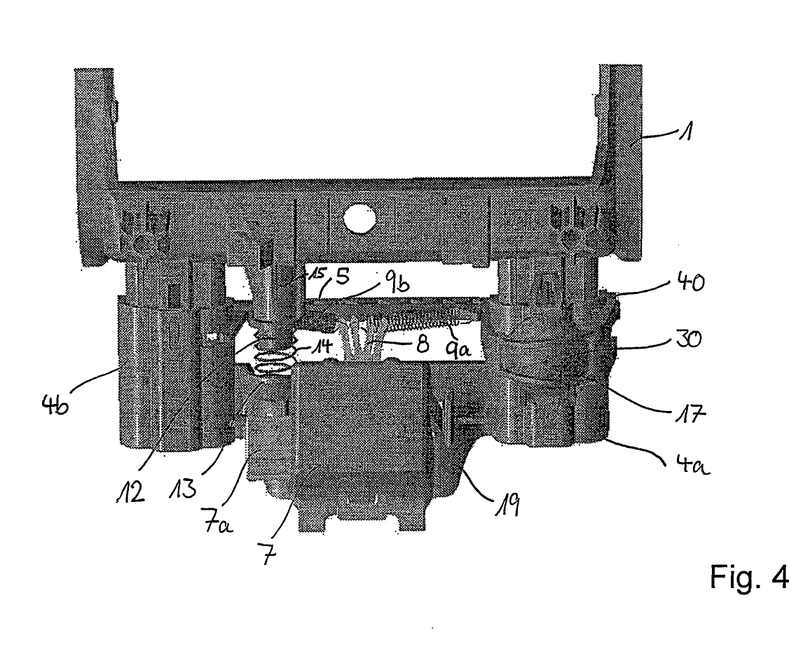

FIG. 4 shows a view of the closing element from below. What can be easily recognised here is the bore-type guide 15 for the release pin 12. Furthermore the rollover safety device 17 is shown from below, including the mounting 40 for securing the rollover safety device to the housing 4a of the closing catch 3a.

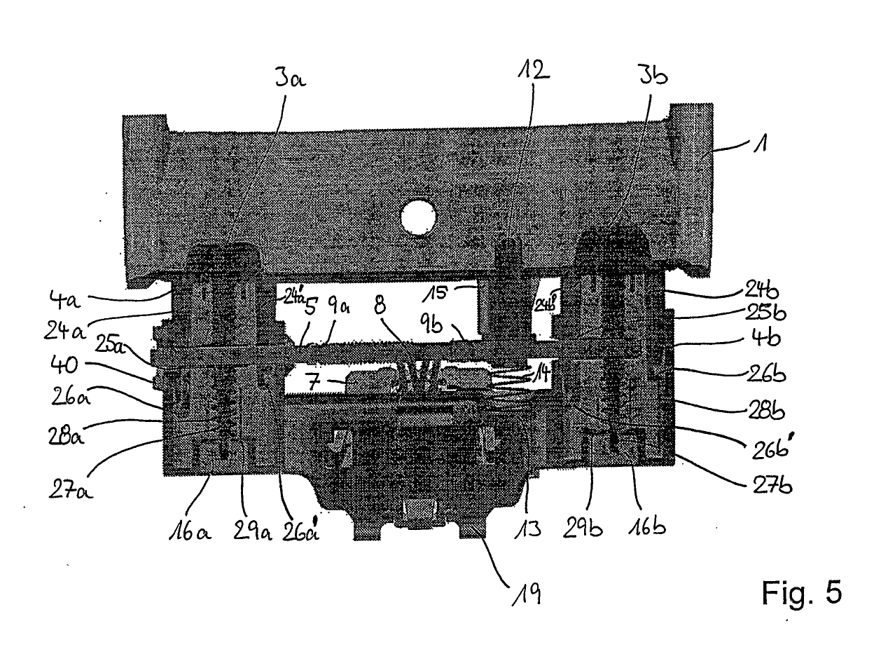

FIG. 5 shows a section through the closing system according to the invention, the section being only partial here, namely through the housing 4a and 4b and through the guide 15.

It can be recognised here that the closing catches 3a and 3b are guided inside their housings 4a and 4b by the corresponding walls of the housings 4a and 4b. The closing catches 3a and 3b have walls 24a or 24b respectively extending into the housings 4a and 4b. Furthermore, each closing catch 3a or 3b has a guide pin 27a or 27b which is supported by a spring 28a, 28b on a bearing 29a or 29b. This guarantees that the closing catches 3a and 3b normally always attempt to disengage from their housing in the direction of the opening. Complete disengagement of the closing catches 3a and 3b is prevented by the lateral flanges 26a, 26a′ or 26b, 26b′ which are designed as stops and which, when the closing catches 3a and 3b are disengaged to the maximum extent, come into engagement with projections in the wall of the housings 4a and 4b. The housing 4a or 4b has furthermore in each case an opening 16a or 16b through which the respective guide pin 27a or 27b can emerge when the closing catches are pressed out of the housing 4a or 4b respectively.

It can be furthermore recognised in this figure that the walls 24a and 24b′ each have a recess or grooves 25a or 25b respectively, in which the engagement elements 6a or 6b of the stay bar 5 engage when the stay bar 5 is in its second position, and thus can fix the closing catches 3a and 3b.

This is illustrated again more clearly in FIG. 6, in which it can be seen that the stay bar 5 is not yet in the second position since the engagement element 6a is not yet engaged in the recess 25a in the closing catch 3a. The closing catch 3a is thus still completely displaceable inside the path predetermined by the flanges 26a, 26a′.

FIG. 7 shows a detailed representation of the rollover or crash safety device 17 which is intended to lock the closing catch 3a in the event of high forces or great acceleration being exerted on the closing element.

It can also be recognised that the safety device 17 has a socket 30 which bears a ball. The ball is covered on its other side by a lever 32 which can also be extended socket-like in the region of the ball. This lever 32 is rotatably mounted by means of a swivel-joint 35 at one of its ends.

The socket therefore forms a lower part and the lever 32 an upper part for enclosing the ball. The lower part extends now on both sides of the socket 30 and forms at the mounted end of the lever 32 a receiver 36a for a spring, to which an appropriate receiver 36b on the mounted end of the lever 32 corresponds. These two receivers 36a and 36b provide the bearing for a spring which in the normal state presses the lever onto the ball. At the other end, the lever 32 is mounted by means of a guide pin 39 in a guide 38, which only permits a vertical movement of the lever in the direction of the closing catch 3a. This guide 38 forms part of the lower part of the ball receiver. At the same end of the lever 32, a pin 33 protrudes in the direction of the closing catch 3a and bears teeth at its free end. The closing catch 3a for its part has on its underside a series of teeth or tooth-like depressions 34 which corresponds to the teeth of the pin 33.

It should be emphasized here that as or instead of a pin 33, any type of element of any shape can be provided which is suitable on its upper side for engaging in corresponding recesses in the closing catch 3a.

In the event of an accident or the vehicle overturning, a strong force acts now on the ball such that the ball moves the lever 32 upwards against the force of the spring 37 and thus brings the pin 33 into engagement with the teeth 34 on the underside of the closing catch 3a. Thus during the accident the closing catch 3a is then locked such that a cover secured with the closing catch 3a cannot open.

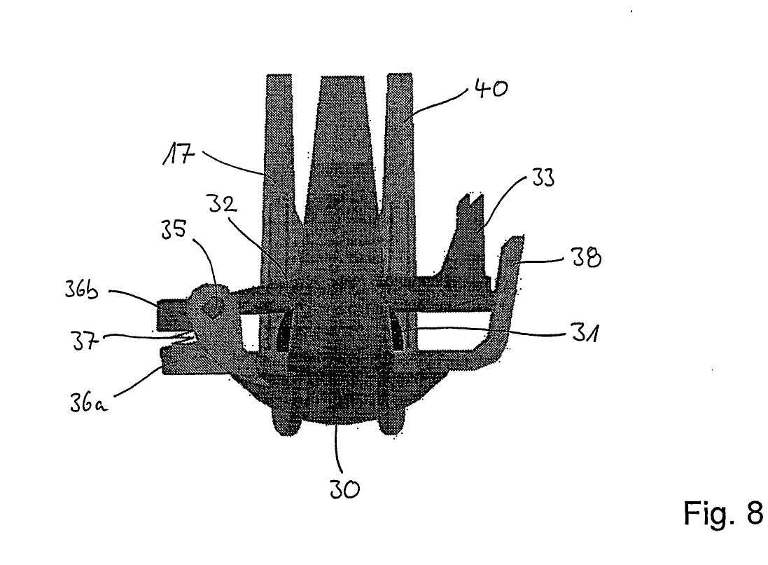

FIG. 8 shows a further view of the safety device 17 from the opposite side in comparison with FIG. 7. Again the mounting elements 40 can be recognised by means of which the safety device 17 is secured to the housing 4a of the closing catch 3a. In this view, the ball 31 can also be recognised which is mounted between the socket 30 and the lever 32 which is extended socket-like.

1-31. (canceled)

32. A closing element of a housing which is closing with a cover, comprising:
a closing frame at least partially covering an opening of the housing;
at least one closing catch mounted in a displaceable manner in the frame;
a locking element locking the at least one closing catch;
a drive moving the locking element between a first position and a second position, the drive being one of a manual drive and a motor drive, the first position being a position in which the at least one closing catch is displaceable and not locked, the second position being a position in which the at least one closing catch is locked by the locking element; and
a safety device locking the at least one closing catch if a predetermined condition detected, the predetermined condition including at least one of (i) detecting an acceleration greater than a predetermined acceleration and (ii) detecting a force greater than a predetermined force which is being exerted on the closing element, the safety device including a socket and a ball loosely mounted in the socket, the ball being covered on a first side by a lever arm, the first side being remote from the socket, the lever arm being rotatably mounded in a region of a first end and one of bears and actuates, at an upper side, an element engageable in a corresponding recess in the at least one closing catch so that, if the predetermined condition is detected, the element engages in the recess arranged on the at least one closing catch to be locked by the safety device.

33. The closing element according to claim 32, wherein the closing element is a pin and the corresponding recess is at least one groove.

34. The closing element according to claim 33, wherein the pin has teeth to provide engagement.

35. The closing element according to claim 32, wherein the at least one closing catch has, as engagement grooves, a row of teeth orientated along a direction of movement of the at least one closing catch.

36. The closing element according to claim 32, wherein the locking element is a stay bar which is mounted so as to be displaceable in its longitudinal direction.

37. The closing element according to claim 36, wherein the stay bar one of (i) extends in the longitudinal direction between first and second closing catches of the at least one closing catch and (ii) engages over the first and second closing catches.

38. The closing element according to claim 36, wherein the stay bar has a lug which is engaging with a groove, the lug being situated in a region of at least one of ends of the stay bar, the grove being arranged in at least one of the first and second closing catches.

39. The closing element according to claim 32, further comprising:
an unlocking element moving between the first position and the second position, the unlocking element cooperating with the locking element so that when the unlocking element in the first position, the locking element cannot assume the second position, and when the unlocking element in the second position, a movement of the locking element is unrestricted.

40. The closing element according to claim 39, wherein when the unlocking element is in the first position, the locking element assumes, instead of the second position, a third position, wherein when the locking element in the third position, the at least one closing catch is unlocked by the locking element.

41. The closing element according to claim 39, wherein the unlocking element is a release pin which is resiliently mounted in a longitudinal direction, the unlocking element being arranged so that the unlocking element is displaceable in the same way as the at least one closing catch and assumes one of (i) the first position in a non-depressed state and (ii) the second position in a depressed state.

42. The closing element according to claim 41, wherein when the release pin passing from the second position into the first position, a first driver of the release pin grasps a second driver of the locking element and transfers the locking element into a third position, wherein when the release pin in the first position, if the locking element moves from the first position in a direction of the second position, the realse pin engages with the second driver on reaching the third position of the locking element and blocks further movement of the locking element, the third position of the locking element being a position which when the unlocking element is in the first position, the locking element assumes, instead of the second position, the third position, wherein when the locking element is in the third position, the at least one closing catch is unlocked by the locking element.

43. The closing element according to claim 32, wherein a first closing catch of the at least one closing catch is arranged beside a second closing catch of the at least one closing catch, wherein only the first closing catch is able to be locked by at least one of the locking element and the safety device.

44. The closing element according to claim 32, wherein the at least one closing catch has a lead-in slope at an end on two opposite sides.

45. The closing element according to claim 32, wherein the motor drive moves the locking element between the first position and the second position.

46. A housing having an opening and a cover for closing the opening, comprising:
a closing element according to claim 32,
wherein the at least one closing catch is arranged along a circumferential edge of the opening, the at least one closing catch being mounted so that, as the cover is closed, the at least one closing catch is pressed into the frame, at least one depression being arranged on the cover and receiving the closing catch when the cover is closed.

47. The housing according to claim 46, wherein an unlocking element is mounted on the frame so as to be displaceable along the circumferential edge of the opening, wherein when the cover is closed, the unlocking element is pressed into the frame and assumes the second position, the unlocking element protruding in a non-depressed state out of the frame and assuming the first position, wherein the unlocking element cooperates with the locking element so that in the first position, the locking element cannot assume the second position and in the second position a movement of the locking element is unrestricted.

48. The housing according to claim 47, wherein when the unlocking element is located in the first position, the locking element assumes, instead of the second position, a third position, the third position being similar to the first position and being between the first position and the second position, wherein, in the third position, the closing catches are not locked by the locking element.

49. The housing according to claim 47, wherein the unlocking element is a release pin, the release pin being resiliently mounted in a longitudinal direction, the release pin, in the second position, protruding from the frame.

50. The housing according to claim 49, wherein when the release pin passing from the second position into the first position, a first driver of the release grasps a second driver of the locking element and transfers the locking element into a third position, wherein when the release pin in the first position, if the locking element moves from the first position in a direction of the second position, the release pin engages with the second driver on reaching the third position of the locking element and blocks further movement of the locking element, the third position of the locking element being a position which when the unlocking element is in the first position, the locking element assumes, instead of the second position, the third position, wherein when the locking element is in the third position, the at least one closing catch is unlocked by the locking element.

51. The housing according to claim 46, wherein first and second closing catches of the at least one closing catch are arranged along a circumference of the opening, and wherein at least one of the first and second closing catches is able to be locked by at least one of the locking element and the safety device.
